(19) United States
(12) Patent Application Publication
(10) Pub. No.: US 2024/0039883 A1
(43) Pub. Date: Feb. 1, 2024

(54) Duck it

(71) Applicants: Leonard Michael Volpe, Tampa, FL (US); Tammy Lynn Volpe, Tampa, FL (US)

(72) Inventors: Leonard Michael Volpe, Tampa, FL (US); Tammy Lynn Volpe, Tampa, FL (US)

(21) Appl. No.: 17/878,018

(22) Filed: Jul. 31, 2022

(51) Int. Cl. H04L 51/52; G06F 3/0482

(52) U.S. Cl. CPC H04L 51/52; G06F 3/0482

(57) ABSTRACT

Our software program that will be used on computers and mobile applications will allow members who signed up the ability to send virtual duck images and messages to existing members who download our software program. A member's information they enter is then generated into a specific individual QR code that identifies them as a jeep owner and helps achieve the process in utilizing many of the functions within the software program. Members will be able to create profiles, text each other, send virtual ducks, play interactive games, look at a yearly calendar of events and participate in our informational forums.

This software program was developed for computers and mobile devices. The computer program works with the mobile application after the user downloads the program. Once a member creates a login account and downloads the mobile application a member is allowed access to the software program that will allow them to communicate with other members using our mobile application.

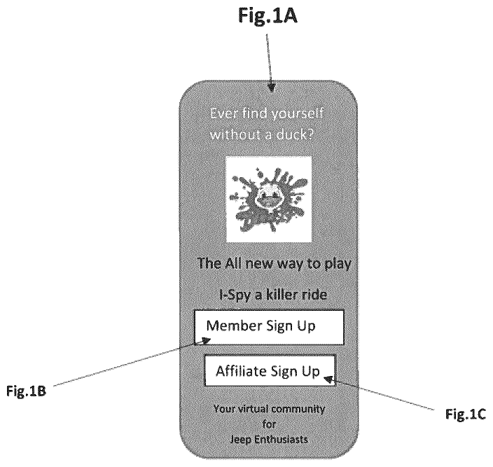

Is the Duck it Home page FIG. 1A which includes a member sign up button FIG. 1B and an Affiliate sign up button FIG. 1C. The member sign up button FIG. 1B is where an individual may choose to sign up for to use our mobile application. A member sign up will take that member to the individual biographical page. This is used for members who are not affiliates. This information that is filled out by them helps them describe themselves. A member is allowed to use pictures they can upload from their mobile phone lap top, computer or tablet. A member can list their name, nickname or even their jeep name along with the city they live in along with their favorite jeep pets. They can continue to enter information of affiliations “jeep groups” they might belong to. Here they can also list jeeps they may own. Members will also be able to access their privacy on/off button for their GPS shared location that only they can control. Information is entered by the member by a key pad containing alphanumeric keys that is used to input any information needed into any fields that are needed. The Affiliate sign up button FIG. 1C is where a affiliate member may choose to sign up for to use our mobile application. An affiliate member sign up will take that member to the affiliate biographical page. This is used for members who are not individual member sign ups. This page will be used for any Jeep affiliations to enter their information. The Affiliation Biographical page contains information that is put in by the individual using the alphanumeric Key pad at the bottom of the screen. A member may upload a picture for their profile picture from their phone camera, computer, lap top or tablet. The jeep affiliation name section is where a member would enter their Affiliation or affiliations that they currently belong to along with the affiliation city they are located in. When an affiliate member signs up in this section they are also able to list their business and address. This will generate a duck on our interactive map to signify where their business is located.

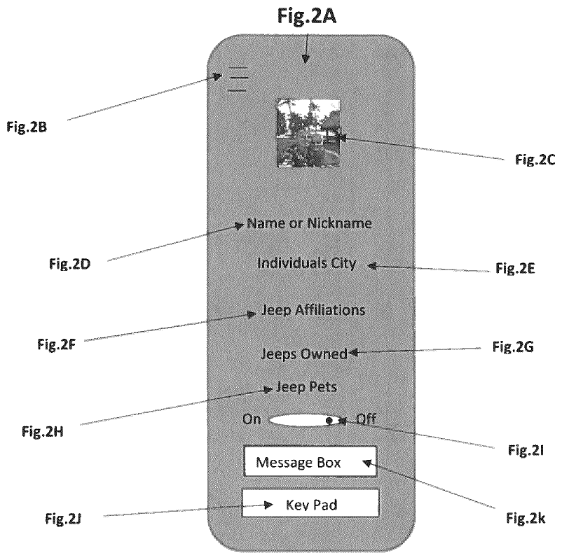

Is the Individual Biographical page FIG. 2A which includes a menu button, profile picture, Individuals name/nickname, individual city, jeep affiliations, jeeps owned, jeep pets, privacy on/off button, alphanumeric key pad and message box. FIG. 2B is the menu button is in the upper left side and will always be able to access to pull up the full menu of options offered in the App. FIG. 2C is the profile picture button. A member may upload a picture for their profile picture from either their phone camera, computer, lap top or tablet. A picture can be uploaded of the jeep member, their Jeep, or using our prefabricated ducks for their profile picture. FIG. 2D is the Individuals name/nickname section where a member can list any combination of their own name, nickname or they name they call their jeep. FIG. 2E Is the city button where an individual will be able to type in the city they live in. FIG. 2F is the jeep affiliation section where members can enter any Jeep affiliations that they currently belong to. FIG. 2G is the jeep owned section where members are able to list their current jeep they own. FIG. 2H Is the jeep pets section where a member can list their pets who drive with them in their jeeps.

FIG. 2I is the privacy on/off button. The privacy button enables a member to share their information with another Duck it member if they choose to. By sliding the privacy button on or off will determine if a member makes their information for private use or public use. The privacy button is controlled only by the Duck it member and is only turned on by the Duck it member. FIG. 2J is the key pad that allows an individual to enter all the information needed using an alphanumeric key pad. An individual will use this key pad to enter all information they need when utilizing the jeep mobile application in the various sections. FIG. 2K is the message box that allows a member to communicate to other mobile app members by typing anything they choose in this box.

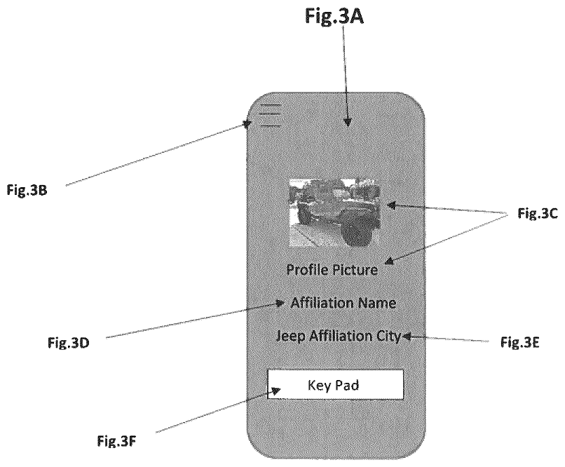

Is the Jeep Affiliations Biographical page FIG. 3A that contains the menu button, the profile picture, jeep affiliation name, jeep affiliation city and alphanumeric key pad. FIG. 3B Is the menu button is in the upper left side and will always be able to access to pull up the full menu of options offered in the App. FIG. 3C is the profile picture button. A member may upload a picture for their profile picture from either their phone camera, computer, lap top or tablet. A picture can be uploaded of the Duck it jeep member, their Jeep, or using our prefabricated ducks for their profile picture. FIG. 3D is the jeep affiliation section where a member can enter the affiliation that they started as well as list other jeep affiliations they are members of. FIG. 3E is the city button where an individual will be able to type in the city they live in. FIG. 3F is the key pad that allows an individual to enter all the information needed using an alphanumeric key pad. An individual will use this key pad to enter all information they need when utilizing the mobile application in the various sections.

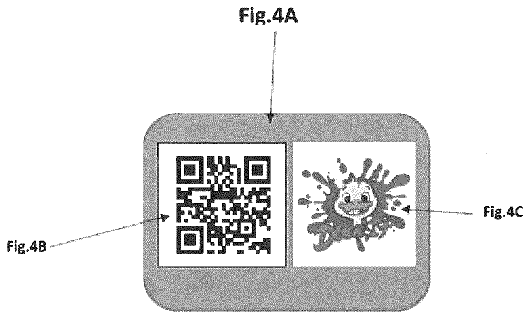

Is the QR code page FIG. 4A. This page consists of half of the page being the Individual dynamic QR code and the other half being our Duck it logo. This page is also printed on a static sticker we provide to all our duck it mobile app members which we mail out to them after we print them. FIG. 4B is the Individual dynamic QR code generated section. The information the duck it jeep member fills out on their biographical page will allow us make up individual QR codes for each member. They will be able to share their QR code with anybody that seans the QR code either on their phone or using the static sticker. FIG. 4C is the duck it mobile app logo.

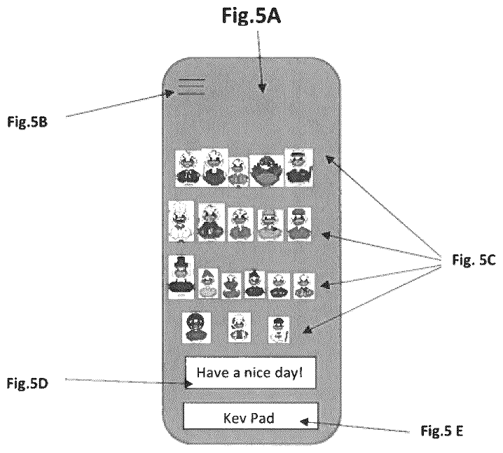

Is your Duck Selection page of our prefabricated ducks FIG. 5A. This page consists of the menu button, various prefabricated and custom ducks. It also includes an alphanumeric keypad to be able to text information or leave another duck it mobile app member a message. FIG. 5B is the menu button is in the upper left side and will always be able to access to pull up the full menu of options offered in the App. FIG. 5C This section allows you to select multiple ducks by scrolling and selecting a

Tammy Lynn Volpe USA, Tampa Florida duck that we presented for your selection. Your duck selection is based off of but not limited to these duck selection categories; Military, First responders, EMT, Paramedics, Nurses, Doctors, MD's EYE DR's Dentists, Sport Teams, NFL, Basketball, NHL, Super hero, Pirate, Holiday and Animals. FIG. 5D is the message box to leave message. FIG. 5E is the key pad that allows an individual to enter all the information needed using an alphanumeric key pad. An individual will use this key pad to enter all information they need to when utilizing the mobile application in the various sections.

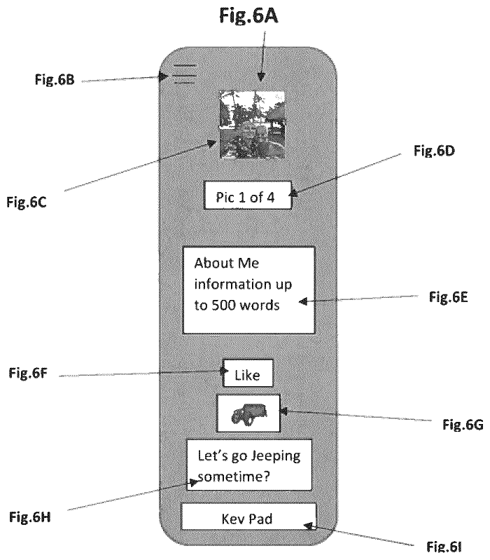

Is the Dating Biographical page FIG. 6A that consists of a menu button, profile pictures, a slide view picture frame advancer, a about me section, a jeep like button, a change of color jeep color image, a message box and an alphanumeric key pad. FIG. 6B is the menu button is in the upper left side and will always be able to access to pull up the full menu of options offered in the App. FIG. 6C is the dating profile picture button. A member may upload as many as 4 pictures for their profile picture from either their phone camera, computer, lap top or tablet. A picture can be uploaded of the Duck it jeep member, their Jeep, or using our prefabricated ducks for their profile picture. FIG. 6 is the slide view picture frame advancer. This allows a member to be able to swipe their finger left or right to advance the next picture image. FIG. 6E is the about me section will allow a subscribing member to describe themselves in 500 words or less. FIG. 6F is the like button; when you hit the button it will turn the image of a jeep (FIG. 6G) from white to a red jeep in color. FIG. 6G is the jeep image that starts off being white until you click the like button (FIG. 6F) and then after you click the like button it tums the jeep color to red. FIG. 6H is the message box that allows a member to communicate to other Duck it jeep mobile app members. FIG. 6I Is the key pad that allows an individual to enter all the information needed using an alphanumeric key pad. An individual will use this key pad to enter all information they need to when utilizing the mobile application in the various sections.

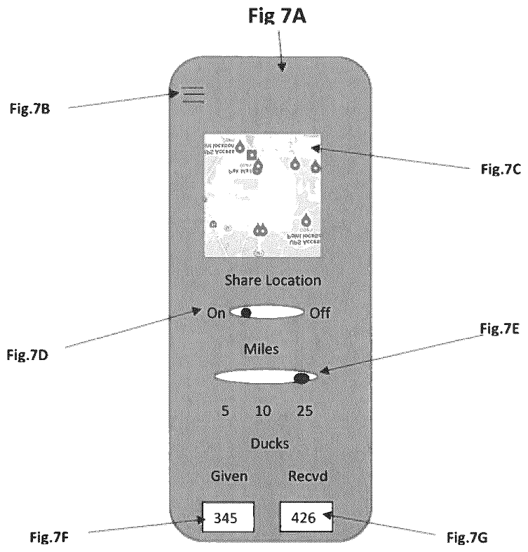

Is the Jeep Hunting interactive game page FIG. 7A that consists of a menu button, a GPS live shared location map, a share location on/off button, a miles selection button with ranges of miles to choose from { 5, 10, 25}, a ducks given tally recorder counter and a ducks received tally recorder counter. FIG. 7B is the menu button is in the upper left side and will always be able to access to pull up the full menu of options offered in the App. FIG. 7C is the interactive game we create using a members GPS location. A member will be able to see themselves on this live map as well as other Duck it jeep mobile app members when a member turns on their share location button to play the game. This allows members to seek out other members in the area and go “duck hunting” to give them a virtual duck and message. FIG. 7D is the share location button with on/off choices that are controlled ONLY by a member themselves. When a member turns on their GPS locator it allows them to share their current live location on the live map with other mobile app members that want to play the game. If a Duck it mobile app member turns off their location then no other Duck it mobile app members will be able to locate their current location. FIG. 7E is the miles selection button that a member can choose different miles location from 5, 10 or 25 miles near your GPS location to play the duck hunting game. Only members who select the “On” position will share their GPS location and be able to play the game. FIG. 7F is the ducks given tally button. This keeps track of all the amounts of ducks a mobile app member has given to other mobile app members. FIG. 7G is the ducks received tally button. This keeps track of all the amounts of ducks a mobile app member has received from other mobile app members.

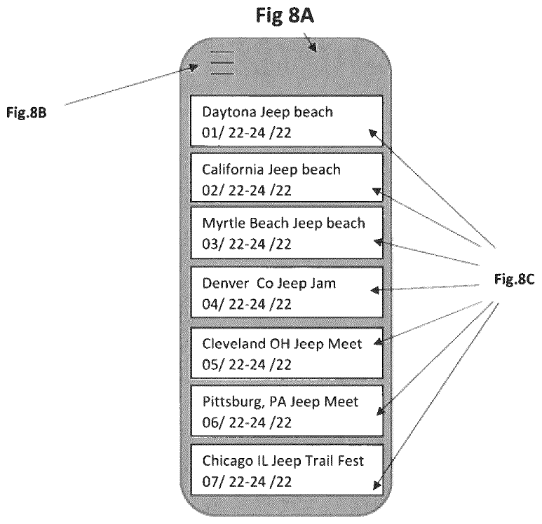

Is the Event page FIG. 8A that consists of the menu button and a listing of jeep events locally, nationally and worldwide. FIG. 8B is the menu button is in the upper left side and will always be able to access to pull up the full menu of options offered in the App. FIG. 8C is the jeep events section that will display any events locally, nationally and worldwide that we have entered into our Duck it mobile app for other Duck it mobile app jeep users.

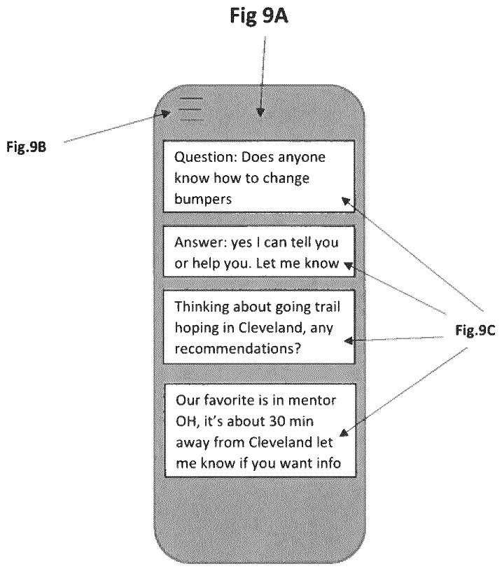

Is the Jeep Forums page FIG. 9A that consists of the menu button and the Duck it mobile app forum information. FIG. 9B Is the menu button is in the upper left side and will always be able to access to pull up the full menu of options offered in the App. FIG. 9C Is the jeep forums page that will allow duck it mobile app members to communicate in reference to an open forum talk or serious of questions. Other duck it jeep mobile app members will be able to comment in the open forums.

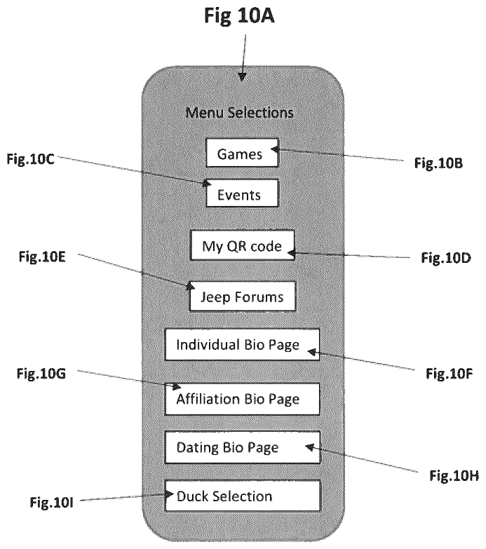

Is the Menu button FIG. 10A that can be accessed throughout the Duck it mobile app that consists of games, events, my QR code, jeep forums, individual bio page, affiliation bio page, dating bio page and duck selection. FIG. 10B is the game button, when this button is pressed it will automatically take you to that designated section of the duck it jeep mobile app section. FIG. 10C is the events button, when this button is pressed it will automatically take you to that designated section of the duck it jeep mobile app section. FIG. 10D is the QR code button, when this button is pressed it will automatically take you to that designated section of the duck it jeep mobile app section. FIG. 10E is the jeep forums button, when this button is pressed it will automatically take you to that designated section of the duck it jeep mobile app section. FIG. 10F is the individual bio page button, when this button is pressed it will automatically take you to that designated section of the duck it jeep mobile app section. FIG. 10G is the affiliation bio page button, when this button is pressed it will automatically take you to that designated section of the duck it jeep mobile app section. FIG. 10H is the dating bio page button, when this button is pressed it will automatically take you to that designated section of the duck it jeep mobile app section. FIG. 10I is the duck selection button, when this is pressed it will automatically take you to that designated section of the duck it jeep mobile app section.

1. A member sign up will take that member to the individual biographical page. This is used for members who are not affiliates. This information that is filled out by them helps them describe themselves. A member is allowed to use pictures they can upload from their mobile phone lap top, computer or tablet. A member can list their name, nickname or even their jeep name along with the city they live in along with their favorite jeep pets. They can continue to enter information of affiliations “jeep groups” they might belong to. Here they can also list jeeps they may own. Members will also be able to access their privacy on/off button for their GPS shared location that only they can control. Information is entered by the member by a key pad containing alphanumeric keys that is used to input any information needed into any fields that are needed.

2. An affiliate member sign up will take that member to the affiliate biographical page. This is used for members who are not individual member sign ups. This page will be used for any Jeep affiliations to enter their information. The Affiliation Biographical page contains information that is put in by the individual using the alphanumeric Key pad at the bottom of the screen. A member may upload a picture for their profile picture from their phone camera, computer, lap top or tablet. The jeep affiliation name section is where a member would enter their Affiliation or affiliations that they currently belong to along with the affiliation city they are located in. When an affiliate member signs up in this section they are also able to list their business and address. This will generate a duck on our interactive map to signify where their business is located.

3. QR section is designed specifically for that member signs up in either the Individual sign up or the affiliate sign up and is completed all the sections the information will be then used to create a personal QR code specifically for that member to use with our software program. The QR code is printed on a static sticker and is attached to that particular members Jeep window, a member may also pull up the QR code by choosing the menu selection button and then selecting the QR code button. This QR code allows any members to scan each other's QR codes. When the QR code is scanned it will open and allow the person who scanned the QR code to interact with a member to which the QR code belongs to. The interaction is limited to sending a virtual duck that we have prefabricated and trying to Copyright along with a text message they can also send along with the virtual duck if they choose. An example of a text message would be; “nice jeep”. They may choose from many of our prefabricated ducks or they may leave a custom duck that they can help design by choosing a duck and then choosing various accessories.

4. In the duck selection is our prefabricated copyrighted ducks. These ducks are made to be given virtually instead of the traditional way of leaving a rubber duck on someone's jeep. Our inventory of virtual ducks consists of but not limited to Military, First responders, Nurses, Doctors, Sport teams, Super hero, Pirates, holidays, animals and many more. We also have accessories that you can custom design your duck with hair, clothes and glasses or earrings. Our prefabricated copyrighted duck selections are constantly being added with new choices for the members to choose.

5. The dating biographical page is a page on the mobile application and web page that allows jeep members to connect on a more personal level with other Duck it jeep members who also have signed up and downloaded the software. Here they are able to add more profile pictures. These profile pictures they can upload from their phone, computer, laptop or tablet. Nude, naked or partially nude or naked are prohibited. If a member posts any type of prohibited nude pictures they will be immediately canceled for their membership. A total of 4 additional picture can be taken or uploaded from their cell phone, tablet or computer. On this section a member also has an “about me” section so they may be able to talk about themselves in 100 words or less. This section also allows a member to scroll through other jeep members in which they have chosen allowing their profile to be viewed by other jeep members. If a member sees a profile they like, they can turn the white jeep to a red jeep and let the other member know they like their profile. They will also be able to leave a message or communicate to each other through the message box.

6. The Jeep Forums section allows Duck it members to communicate on a continuous feed section. This section allows members to ask questions about anything to do with jeeps and allows other jeep members to respond to the jeep member who had the question. The continuous feed will allow any members to scroll through and read about any questions or answers other jeep members have posted or scroll through to see conversations relating to any jeep content.

7. The Events section is to keep all jeep events listed that are in various areas inside or outside the United States. The information will be sent to us through research from other jeep members. When we have the information of an event we will post it on out calendar for other jeep members to see and provide them with a link to that event if they decide to attend or want more information on the event.
The javatar section is a place that a member can create their own javatar of oneself. This is where a member can select various options and characteristics that will allow the javatar to look more like them by choosing the tool bar selection. In this tool selection section it will allow you choose male/ female, body types, facial features, hair, head, eye color, eye shape, nose and ears to make your javatar look more like yourself.

8. Our game section includes our jeep hunting interactive game that may be accessed through the menu bar and be selected to open up this section of the mobile application. This game allows members to use their GPS to find other members by their location. Everyone's location is then Enabled to be seen on the live interactive map in this section of the mobile application. Each member will have two option buttons that will control privacy settings to share their location with everyone or they have an option not to share. The other button is to select the distance miles in increments of 5 mile, 10 miles or 25 miles radius from their location in which they can find other members close to them. There are two tally sections that are able to count the amount of ducks that a person has given as well as count the amount of ducks that a person has received.
